(19) United States
(12) Patent Application Publication
(10) Pub. No.: US 2008/0290187 A1
(43) Pub. Date: Nov. 27, 2008

(54) PNEUMATIC PAINTING APPARATUS WITH SPRAY GUN, HEATER DEVICE, AND DEHUMIDIFIER/DRIER DEVICE PROVIDED WITH A REGENERATING DEVICE FOR THE ADSORPTIVE AGENT FOR FLUIDIFYING THE PAINT

(75) Inventor: Paolo ZANETTI, Conegliano (IT)

Correspondence Address: EGBERT LAW OFFICES, 412 MAIN STREET, 7TH FLOOR, HOUSTON, TX, 77002, US

(73) Assignee: WALMEC SPA, Milano (IT)

(21) Appl. No.: 12/125,271

(22) Filed: May 22, 2008

(30) Foreign Application Priority Data
May 22, 2007 (IT) TV2007A000090

(51) Int. Cl. B05B 7/16; B05B 12/10

(52) U.S. Cl. 239/75; 239/135; 239/338

(57) ABSTRACT

Pneumatic painting apparatus of the present invention includes a compressor, a de-humidifier device, a heater for compressed air, a regenerating device for an adsorptive agent, a spray gun with a temperature sensor, a delivery pipe, and a control unit. The control unit opens upstream from the de-humidifier device. The circuit, along which the flow of air from the container of compressed air travels, includes passing through at least the heater and going along the delivery pipe of the compressed air flow towards a spray gun or vice-versa, not supplying the spray gun. The upstream circuit of the de-humidifier device closes, activating the regenerating device for the adsorptive agent of the de-humidifier device. The circuit takes a regenerating path inverse to the previous one, the circuit, from the compressed air container first crossing the heater device and later the de-humidifier device.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The object of this invention is a painting apparatus of the pneumatic type which provides for the use of at least one spray gun with an integrated heater device, de-humidifier/drier device and regenerating device for the de-humidifier/drier device's adsorptive agent for fluidifying the paint.

2. Description of Related Art Including Information Disclosed Under 37 CFR 1.97 and 37 CFR 1.98

Spray guns are known. Together with a compressor group, they are part of the equipment for carrying out the pneumatic-spray painting of surfaces, for example of motor vehicle bodywork.

In principle, the equipment, for painting decorative or protective aims, is made up, respectively from:
a compressor/pump group and relative container, mainly being portable and supported by its own frame, with a related supply and control unit;
a flexible supply pipe, between the compressor group and the spray gun;
a pneumatic spray gun connected by means of the flexible supply pipe to the compressor group, wherein the nebulization of the painting product occurs by compressed air action through the spray gun, supplied by a cup placed on the upper part for gravity or a cup placed on the lower part for suctions; and
a cup or vessel containing the paint joined to the spray gun.

Painting is intended as the process that allows for the coating of a support with both decorative and protective aims. The painting cycle indicates the application process of different painting products, chosen to give the support to the desired aesthetic effect and chemical-physical characteristics. The painting cycle further consists of a series of operations, respectively:
sandpapering the support;
color-washing and ennobling, when necessary;
modifying the color or making the color of the support uniform;
insulating, when necessary;
filling;
applying one or more base coats for filling out the pores of the support to the desired measure;
sandpapering the base; and
finishing application of the painting product final layer to give the support the desired aesthetic effect and chemical-physical characteristics.

At the beginning of a painting cycle, it is moreover necessary to check at least the suitability of environmental factors, the features of the product to be painted, the use of the painting product, and the correct use of the application equipment. In particular, first of all, it is necessary to verify:
the environmental humidity must be between 40% and 75%;
the ideal environmental temperature is between 18° C. and 22° C.; and
the environment must be free of dust and from other possible polluting factors.

Finally, one must also consider legislation, such as the Legislative Decree 27 Mar. 2006, n. 161. This decree, in order to prevent or limit the atmospheric pollution derived from the effects of volatile organic compounds (VOC) on the formation of the tropospheric ozone, determines, for paints and products for car bodywork, the maximum VOC content admitted in order to allow the emission on the market.

According to the aforesaid, not excluding the regulations of reference, a significant reduction is set today towards the radical removal of solvent components for diluting paints and varnishes through conventionally used pollutants. These considerations require the operators in this field to prepare paints or varnishes that do not require solvents, that is, the paints and varnishes are made up or based on water, in addition to the chromatic component. However, this is not a simple task. To date, only the use of solvents allowed for achieving extremely exalted finishing objectives, which are essentially linked to rapidity and coating uniformity in relation to the thickness of the coating and the surface treated, independent from environmental and work temperature. Alternatively, the use of water to replace the solvent as part of the mixture suitable for carrying out painting, is a very critical component. The use of the water in the application phase is closely related to the environmental and work temperatures. With environmental and work temperatures below 18° C., the use of water-based painting products becomes extremely difficult, if not arduous, because the molecules of water aggregate, tending to make the painting product less fluid and compromising the result of the finish.

Hence, the need of those skilled in the art is to find better solutions to allow the use of water-based painting products, while maintaining an excellent degree of fluidity for reaching the prearranged objectives. The objectives of water-based painting products are substantially equivalent to the objectives achieved with the conventional products.

A secondary problem, detected in the painting equipment with a conventional spray gun, relates to the need to have a volume of air under pressure. Before being mixed with the paint, the volume of air must arrive at the spray gun in a substantially dehumidified condition.

The air de-humidifier is widely used in the plastic material field. The de-humidifier is applied directly in the process hopper, where, each time, the pellets of resin are loaded. Typically, there is a ventilating system inside the hopper, allowing for the emission of a dry and preferably constant airflow and the emission of air enriched with percentages of variable humidity. Such forced circulation has the aim of progressively cutting down the percent of noticeable humidity inside the hopper, without breaking off operation. Meanwhile, the regenerating of the means used for the de-humidifying of the air is introduced in the hopper.

Equipment suitable for de-humidifying is certainly known. For instance, in JP7039716 (Katayama), an apparatus provided with channels is described. The channels are linked to a beam of microwaves, generated by a convenient device. Moreover, a fan cooperatively provides for the introduction of an airflow. JP62277125 (Takusagawa) describes an absorption tower, in which the use of microwave devices able to optimize the dehumidification process of gaseous and thin material is employed for the regenerating of gas. CA2235887 (Flynn et al) suggests a painting system including a de-humidifier for conditioning the recirculation air towards a spray painting cabin.

The heater devices for painting equipment with a pneumatic spray gun have been known for many years. In principle, they consist of a unit associated to the painting apparatus which provides for the heating of the airflow, then introducing the flow of air at the correct temperature along the hose connecting to the spray gun. The heating unit is therefore placed in an apparatus for the pneumatic spray painting, situated or rather along a path between the exit of the compressed air container of the compressor group and the entry of the airflow in the connecting pipe to the spray gun.

A conventional configuration is known. In particular, a device for the heating of air is able to be associated to an apparatus for painting. The known device, known as AIRTHERM™ or CLEARPOINT™, is placed upstream from the compressed airflow entry in the pipe connecting to the spray gun. In the case of the AIRTHERM™, there is a manual control for the thermoregulation of the air temperature from 20° C. to 100° C. The thermoregulation of the airflow in delivery is carried out through a knob that is rotated in a more predetermined position that adjusts the air temperature.

In U.S. Pat. No. 5,214,740 (Carroll), a device similar to the previous heater devices is described. It concerns a portable heating apparatus for supplying an application spray gun with an inflammable gas. Its positioning along the circuit of the painting apparatus is therefore along a path downstream the compressed air container of a compressor group and upstream from the pipe connected to the application spray gun. A temperature probe provided in the portable heating apparatus allows for the thermo-adjusting of the exit temperature compared to the entry temperature.

WO2006/016256 (Milli) suggests a device for preheating a fluid for spray painting. In particular, it is a device for spray painting that includes a pipe with a first connection to a pressurized fluid and a second connection to a spray gun for the spray painting. The heating means are localized along a portion of its length, supposedly with reference to the pipe. These heating means are placed inside the pipe and in contact with the conductor of the fluid. In an independent claim, reference to a spray painting method is made, including a phase to spray a mixture of a transported hot fluid and a paint on a surface to be painted. The transported flow is kept at a requested temperature, at least at the moment of blending with the paint. The equipment is also provided with a thermocouple, which is placed where the fluid exits the spray gun.

EP1332784 (Milli) describes a membrane apparatus for treating an air supply in a spray painting device. The apparatus, includes:
an entry for the air in pressure;
a heating unit for heating up the compressed air;
a de-humidifier and/or a separating unit operating by means of membrane means;
means for adjusting the heating of the treated air;
means for adjusting the air pressure;
means for the adjustment of the dew point, when the unit has membrane means for the dehumidification of air and/or the adjustment of the residual oxygen percent in the treated air, the unit including membrane means for the production of nitrogen enriched air; and
an exit for the treated air ready for use.

Given the aforesaid, it is reasonable to affirm that in an apparatus for pneumatic painting the following is known. The apparatus includes:
an entry for the air in pressure;
a heating unit for heating up the compressed air;
a de-humidifier and/or a separating unit;
means for adjusting the heating of the treated air;
means for adjusting the air pressure; and
an exit for the treated air ready for use.

The known prior art present advantages; however, they do not seem suitable to be effectively used in an apparatus for pneumatic spray painting by means of a spray gun.

In particular, in U.S. Pat. No. 5,214,740 (Carroll) exclusively, a portable heating apparatus is described for supplying a spray gun. It has placed a temperature sensor means situated in the apparatus, and therefore it does not seem to be able to establish with reasonable certainty the temperature of the air in the proximity of the spray gun's exit. Therefore, the objective of temperature regulation is an impossibility when painting with a fluidity degree of the optimized paint independent from the environmental temperature, which is close to the optimal working temperature for the application.

In WO2006/016256 (Milli), the heating of the air is carried out along the pipe connecting the spray gun and a temperature sensor in proximity of the spray gun's exit. In principle, the evidenced problem relative to the solution U.S. Pat. No. 5,214,740 (Carroll) looks solvable by implementing an analogous solution; however the proposed solution from WO2006/016256 (Milli) appears complex and difficult to realize. Transposing in the equipment of pneumatic spray painting of the conventional type is inconvenient. For both solutions, moreover, a fluid is used, essentially consisting of a gas mixture, that though heated supposedly is not dehumidified. From a practical point of view the result of the application is compromised in a significant way.

In EP1332784 (Milli), providing a de-humidifier device does not seem to allow for regenerating and seems optimized for fluid particular mixtures.

In conclusion, for these and other circumstances, there is a need to find alternative proposals regarding the techniques of the prior art.

### BRIEF SUMMARY OF THE INVENTION

These and other aims are reached by this invention, according to the characteristics in the included claims, solving the exposed problems by means of a painting apparatus of the pneumatic type and with the use of at least one spray gun with integrated heating device, a de-humidifier/drier device and a regenerating device of the adsorptive agent of the de-humidifier/drier device for fluidifying the paint. The painting apparatus includes:
a compressor group that supplies a relatively compressed air container;
a de-humidifier/drier device for compressed air with a regenerating device for the adsorptive agent of the de-humidifier/drier device, being connected to the compressed air container and to a heater device;
a heater device for the compressed airflow connected to the de-humidifier/drier device and to a delivery pipe of the compressed air flow towards a spray gun;
a spray gun with a temperature sensor; and
a control unit in communication with the temperature sensor.

The control unit of the painting apparatus is suitable for opening the de-humidifier/drier device by means of valves upstream. The circuit, along the way of which the airflow from the compressed air container crosses at least the heater device, then runs along the delivery pipe of the compressed air flow towards a spray gun or vice-versa in a condition of not supplying the spray gun. The upstream the de-humidifier/drier device is closed, activating the regenerating device of the adsorptive agent, making a regenerating path for the airflow inverse to the previous circuit. The circuit, from the compressed air container, first crosses the heater device and later the de-humidifier/drier device.

### AIMS AND ADVANTAGES

By the considerable creative contribution of the present invention constitutes an immediate and not negligible technical advancement. Different and important objectives are achieved.

A first aim is obtaining an apparatus for the pneumatic painting with spray gun, being particularly efficient and able to maintain a optimal condition of fluidity of the paint during the application to the support, independent from environmental temperature. In particular, intermediate adjustments are allowed, including adjustments between a position of maximum and minimum working temperature.

A second aim is to allow for the optimal de-humidifying of the compressed airflow and regenerating the adsorptive agent. The de-humidifying content is located inside the de-humidifier device/drier, when the pistol spray gun is not in an operative condition.

A third aim is to obtain the de-humidifying of the adsorptive agent by making the agent pass across a de-humidifier device/drier, made up of a pipe filled with silica gel. Such gel is “regenerated periodically” because adsorbing humidity decreases its de-humidifying efficiency. Heating by means of crossing the hot air flow from the heating device eliminates the absorbed humidity, and a serviceability of 100% is re-obtained.

A fourth aim is to allow for the realization of an apparatus for pneumatic painting with a spray gun, which is not complex, is easily maintained, and is low cost without compromising efficiency.

### COMPARISON WITH THE PRIOR ART

Compared to U.S. Pat. No. 5,214,740 (Carroll), the present invention allows for thermo-regulation of the temperature of the airflow that supplies the spray gun in a more precise way according to the requested working temperature. A temperature sensor is provided at the gunstock of the spray gun, at the entry coming from the supply hose of the compressed air. Moreover the present invention allows for the regenerating function of the airflow by means of the regenerating device, not disclosed in U.S. Pat. No. 5,214,740 (Carroll). An interconnected circuit to the one of the supply of the spray gun considerably improves the application function of the paint on the support, cutting down on moisture, while maintaining a good finish.

Compared to WO2006/016256 (Milli), the present invention provides for a different positioning of the heating device, not being included along the pipe supplying the spray gun. The temperature sensor of the airflow that is the thermocouple provided by WO2006/016256 (Milli) is placed in proximity to the exit of the airflow from the spray gun. While in case of the present invention, it is provided at the entry of the spray gun. In principle, this means less complexity for the apparatus intended as a whole, and easier maintenance, with a discreet containing of costs of purchase and management. Again compared to WO2006/016256 (Milli), the painting apparatus of the present invention allows for the coincidence of the de-humidifying function of the airflow and regenerating the adsorptive agent contained inside the drier/de-humidifier device by means of its regenerating device. The adsorptive agent becomes operative when the spray gun is not in use, considerably improving the application of paint on the support with a better finish.

Finally, compared to EP1332784 (Milli), the present invention is engineered and optimized for functioning with a compressed pneumatic air supply, being different from the prior art use of gas mixtures. In particular, EP1332784 (Milli) uses membrane filtering. In such a device, the regenerating process works differently from the present invention because there is no specific regenerating phase, but rather the regenerating is carried out simultaneously with the production of the dehumidified air. Part of the compressed air produced by the compressor is therefore wasted for such regenerating and is no longer utilized during the painting process, reducing the quantity of effective air for the painting. The present invention provides the possibility of using a lower rate of air-flow compressors, being able to use 100% during the painting phase, with a consequent saving on the purchase of the compressor and its operational expenses. The present invention provides a de-humidifier/drier with a regenerating device of silica gel, being useful not only as regards dehumidification but also filtering of pollutants of various kinds, such as oily substances. Such substances do not alter the dehumidifying performance of the silica gel, but are instead highly harmful for the utilized membranes in the EP 1332784 (Milli) device, making the devices practically unusable. The silica gel is moreover completely disposable without any problem of pollution, while the same is not true for utilized membranes. Finally, in the case of the replacement of filter elements, the cost of silica gel is to be very contained on the contrary of membranes that are very expensive and for correct working must be able to work in a precise arc of temperature, requiring therefore a sophisticated thermo-regulation system that contributes to increasing the cost of the product and its complexity.

In conclusion, these and other aims and advantages, have the value of achieving an apparatus for pneumatic painting with spray gun with a good technological content, contained costs, extremely reliable and, also in particular working conditions.

### BRIEF DESCRIPTION OF THE SEVERAL VIEWS OF THE DRAWINGS

These and other advantages will appear from the following detailed description of a preferred solution with the aid of enclosed schematic drawings whose details of execution are not to be considered restrictive but exclusively illustrative.

FIG. 1 is a schematic view of a diagram of the pneumatic painting apparatus with a spray gun, illustrated in a working condition for the application of the paint on a support.

FIG. 2 is a schematic view of a diagram of the pneumatic painting apparatus with a spray gun of FIG. 1, illustrating a regenerating condition of the contained adsorptive agent inside the drier/de-humidifier device.

### DETAILED DESCRIPTION OF THE INVENTION

The present invention is a painting apparatus 1 of the pneumatic type with spray gun 10, heater device 30 and de-humidifier/drier device 40 for the pressurized airflow. The de-humidifier/drier device 40 has regenerating device 4 for an adsorptive agent contained inside the de-humidifier/drier device 40, fluidifying the paint during the application on a support.

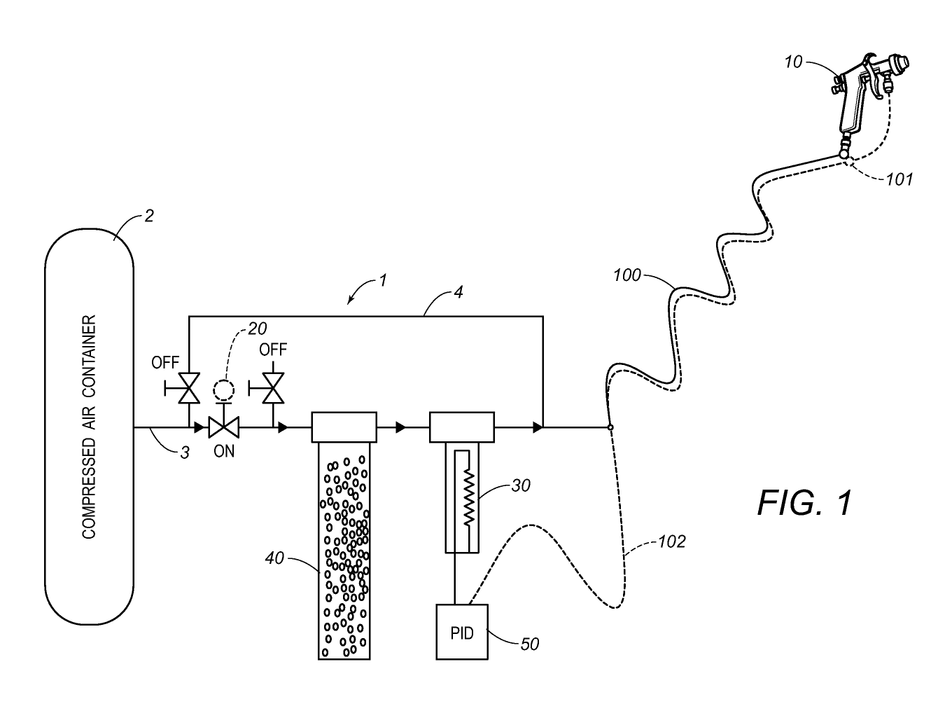

The painting apparatus 1, as represented in FIG. 1, consists of a conventional compressor group (not shown) that supplies a compressed air container 2. The compressed air container 2 has an exit for the compressed air flow inputted into the compressed air flow path circuit 3 for delivery towards at least one spray gun 10. The circuit 3, activated by means of an electro-valve 20, has a position between the supply pipe 100 of the spray gun 10 and the compressed air container 2. For the treatment of the airflow, at least one heater device 30 is conducted across the supply pipe 100 in the spray gun 10. In this case, in the spray gun 10 near the input joint of the supply pipe 100 has a temperature sensor 101 communicating with an adjusting unit 50, the temperature sensor 101 being a thermocouple connected by a connection cable 102. In one possible alternative solution, the communication between the temperature sensor 101 and the adjusting unit 50 is replaced by a wireless communication rather than a connection cable 102.

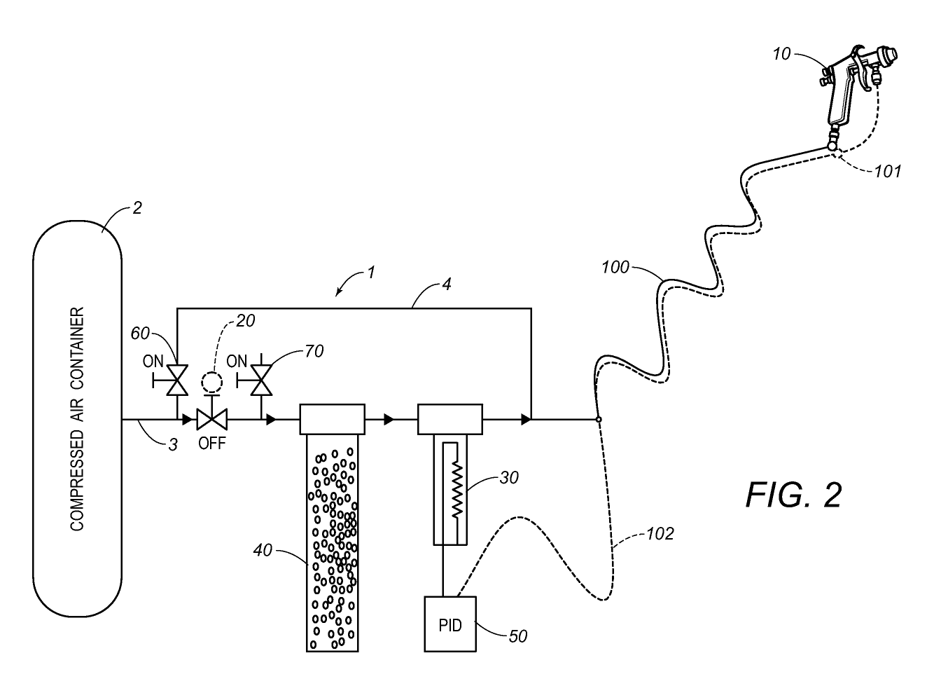

In FIG. 2, a painting apparatus 1 is shown in a regenerating condition of the adsorptive agent of the de-humidifier/drier device 40, when the spray gun 10 is not in an operative condition. More particularly the regenerating device of the adsorptive agent includes a second circuit 4, that bypasses, associates and partially interconnects with the first circuit 3. The second circuit 4 is controlled by the adjusting unit 50 and the control unit 1 of the painting apparatus. The second circuit 4 engages along the downstream portion of the first circuit 3 from the container 2 and before the electro-valve 20, this condition being configured as closed. In this manner, the airflow is brought downstream of the heater device 30, to be started along it and in the opposite direction to that represented in FIG. 1, first across the heater device 30 and later, according to a predetermined degree of temperature, across the de-humidifier/drier device 40. The adsorptive agent provided is the silica gel.

In this condition, the second circuit 4 is provided with an electro-valve 60 in an open configuration, allowing airflow from the compressed air container 2 to be split and started along the second circuit 4 to carry out the described path. A valve 70 for the discharge of the condensation, aqueous vapor and air, is furthermore provided along the path 3 downstream the de-humidifier/drier device 40.

During the painting phase, the de-humidifier/drier device 40 works as de-humidifier, receiving a cold and damp compressed airflow upon entry and producing dehumidified cold air upon exit. Then, the airflow enters the heater device 30 that heats the airflow used for painting.

During the regenerating phase of the adsorptive agent contained inside the de-humidifier/drier device 40, the heater device 30 heats the air. Instead of flowing to the spray gun 10, the airflow crosses an opposite direction and enters the de-humidifier/drier device 40. The latter is now crossed in the opposite direction by a hot air flow. Such air being hot allows the evaporation of humidity and the regenerating of the adsorptive agent contained inside the de-humidifier/drier device 40.

The adjusting unit 50 can be connected to the temperature sensor 101 by means of a wireless device, in such a way as to not have the connection cable 102. The present invention integrates the supply pipe 100 of the compressed air flow that leads to the spray gun 10. Regarding the adjusting unit 50, it is part of the painting apparatus's 1 control unit that manages the adjusting unit 50; alternatively the adjusting unit can be a distinct unit.

1. Painting apparatus being a pneumatic type with at least one spray gun, the apparatus comprising:
a compressor group having a relative container of compressed air;
a de-humidifier/drier device with a regenerating device, said de-humidifier/drier device having an adsorptive agent and being connected to the relative container;
a heater device for the compressed air connected to the de-humidifier/drier device and to a delivery pipe of the compressed air flow;
a spray gun with a temperature sensor, said delivery pipe connected to said spray gun; and
an adjusting unit in communication with said heater device and said temperature sensor.

2. Painting apparatus, according to claim 1, further comprising:
a control unit interactive with said adjusting unit for opening of a valve, upstream from the de-humidifier/drier device, opening of a circuit along which the airflow from the relative container crosses and passing through at least said heater device and along said delivery pipe towards said spray gun and interactive with said adjusting unit for closing said circuit upstream from the de-humidifier/drier device, activating the regenerating device along a regenerating circuit, said regenerating circuit being inverse to said circuit, extending from the relative container, crossing said heater device, and crossing the de-humidifier/drier device.

3. Painting apparatus of the pneumatic type, according to claim 1, wherein said spray gun has a temperature sensor in communication with said adjusting unit near an input joint of a supply pipe of the compressed air.

4. Painting apparatus, according to claim 1, wherein said temperature sensor 101 communicates with said adjusting unit by a connection cable joined to said supply pipe.

5. Painting apparatus, according to claim 1, wherein said temperature sensor is in wireless communication with said adjusting unit.

6. Painting apparatus of claim 1, wherein said adsorptive agent of the de-humidifier/drier is silica gel.
